(19) United States
(12) Patent Application Publication
(10) Pub. No.: US 2026/0242196 A1
(43) Pub. Date: Aug. 20, 2026

(54) LIFT TRUCK UPRIGHT

(71) Applicant: L.T.E. LIFT TRUCK EQUIPMENT S.p.A., Ostellato (FE) (IT)

(72) Inventors: Giovanni Paolo BONELLI, San Lazzaro di Savena (BO) (IT); Luca BORGHETTO, Fiscaglia (FE) (IT); Raffaele FUSCO, Ferrara (FE) (IT); Matteo ZANELLA, Ferrara (FE) (IT)

(21) Appl. No.: 19/152,601

(22) PCT Filed: Feb. 5, 2024
(86) PCT No.: PCT/IB2024/051031

§ 371 Date: Jul. 31, 2025

(30) Foreign Application Priority Data
Feb. 8, 2023 (IT) 102023000002115

(51) Int. Cl. B66F 9/08

(52) U.S. Cl. CPC B66F 9/08

(57) ABSTRACT

An upright of a lift truck having a main extension along a vertical direction and including a unit for picking up a load; the upright comprises a fixed section and one telescopic section, movable relative to the fixed section; the fixed section includes a pair of first profiles, positioned parallel to each other and each first profile has in particular a J-shaped cross-section; the telescopic section includes at least a pair of second profiles, positioned parallel to each other, wherein each second profile has an I-shaped cross-section.

### TECHNICAL FIELD

This invention relates to an upright of a lift truck.

### BACKGROUND ART

Solutions of uprights for lift trucks consisting of respective profiles are described and illustrated in patent documents U.S. Pat. No. 3,394,778A, JPS58220098A, JPS60248599A and CN201240808Y.

### DISCLOSURE OF THE INVENTION

In the technical sector of uprights for lift trucks the need is felt of making innovative solutions which improve the field of vision of the driver without adversely affecting the structural properties to which the upright must respond.

In this context, the Applicant has developed an upright the features of which are set out in independent claim 1.

### BRIEF DESCRIPTION OF DRAWINGS

Further features and advantages of the invention are more apparent from the non-limiting description which follows of a preferred embodiment of an upright of a lift truck as illustrated in the accompanying drawings, in which:

FIG. 1 is a schematic side view of an upright of a lift truck according to the invention;

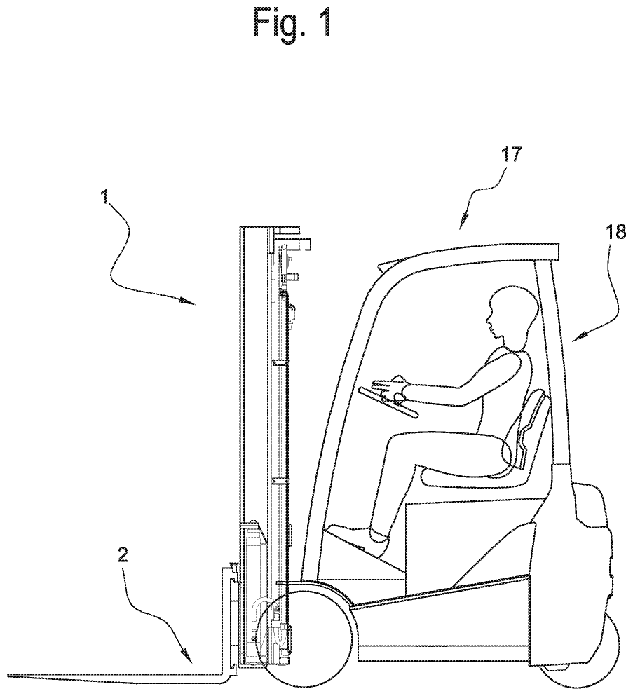

FIG. 2 is a schematic transversal cross section view of an upright of a lift truck showing the profiles of the upright;

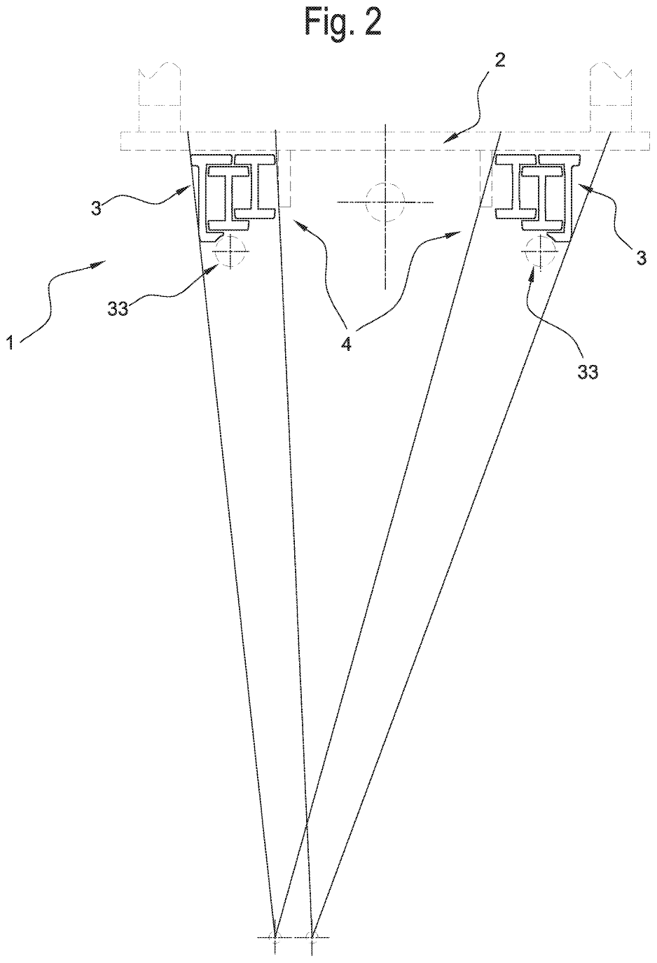

FIG. 3 is a scaled-up view of a detail of FIG. 1;

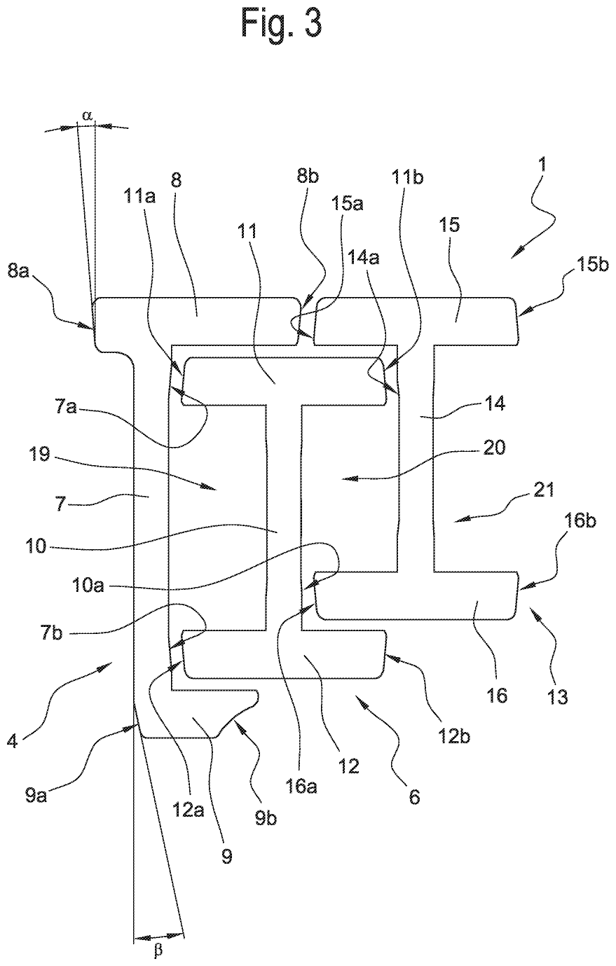

FIG. 4 is a further scaled-up detail of FIG. 1, schematically showing rolling means interposed between the profiles of the upright.

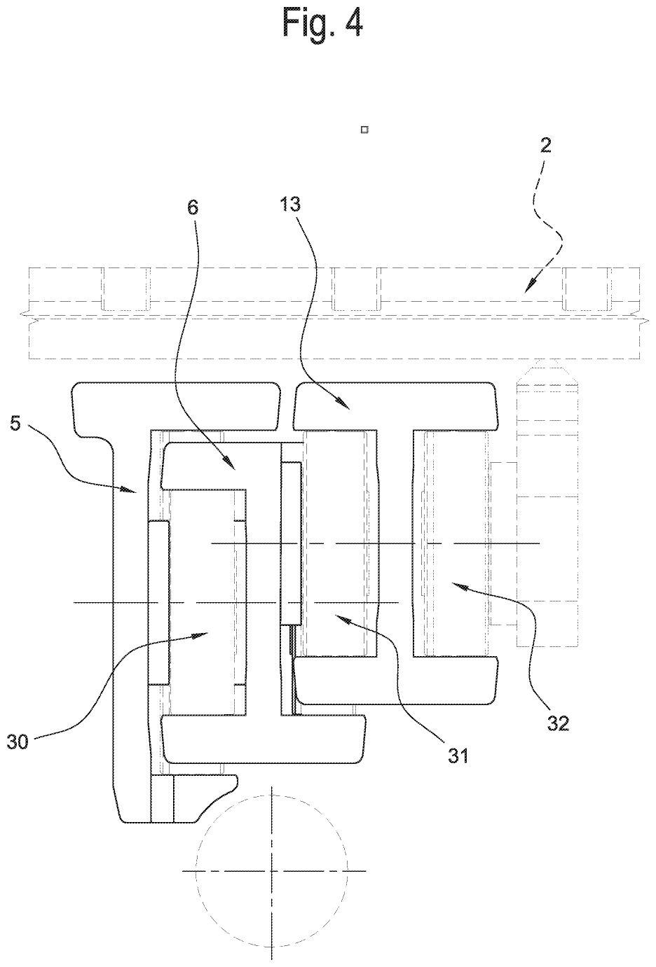

### DETAILED DESCRIPTION OF PREFERRED EMBODIMENTS OF THE INVENTION

The reference numeral 1 denotes an upright of a lift truck having a main extension along a vertical direction.

The upright 1 comprises a unit 2 for picking up a load, preferably comprising a pair of forks.

The upright 1 comprises a fixed section 3 and a telescopic section 4, movable relative to the fixed section 3, for performing the movement along the vertical of the pickup unit 2.

The fixed section 3 has a pair of first profiles 5, positioned parallel to each other and, in particular, each first profile 5 has a J-shaped cross-section.

The telescopic section 4 comprises at least a pair of second profiles 6, positioned parallel to each other and each second profile 6 has an I-shaped cross-section.

It should be noted that this invention applies both to an upright 1 which comprises a single pair of second profiles 6, movable relative to the first profiles 5, the so-called duplex upright, and to an upright 1 which comprises a pair of second profiles 6 and third profiles 13, movable relative to each other, the so-called triplex upright.

Each transversal cross section, in particular J-shaped, of the first profile 5 of the fixed section 3 has a core 7, having a main longitudinal extension, a first flange 8 and a second flange 9 which extend transversely relative to the core 7.

The term “J” is used to denote a shape wherein the longitudinal extension of the core 7 is greater than the extension of the first flange 8 and of the second flange 9 and, in addition, the extension of the first flange 8 is greater than the second flange 9.

The first flange 8 and the second flange 9 of the first profile 5 are positioned parallel and spaced with respect to each other to define a compartment 19 configured to house at least part of a respective second profile 6 the telescopic section 4.

Each first flange 8 and second flange 9 is provided with a respective first end 8a, 9a, positioned along a same side of the respective first profile 5, and a respective second end 8b, 9b, positioned along a same side of the respective first profile 5.

According to this invention, the first end 8a of the first flange 8 and the first end 9a of the second flange 9 have surfaces inclined relative to a main longitudinal direction of extension of the core 7.

The surface of the first end 8a of the first flange 8 is inclined at an angle “α” of between 2° and 20°, preferably 5°.

The second end 8b of the first flange 8 has a surface inclined relative to a main longitudinal direction of extension of the core 7.

The inclined surface of the first end 9a of the second flange 9 is inclined at an angle “β” of between 2° and 20°, preferably 12°.

Advantageously, the inclination of the surface of the first end 8a of the first flange 8 and of the first end 9a of the second flange 9 improve the visibility of the driver of the lift truck.

The second end 9b of the second flange 9 has a curvilinear portion configured to enclose at least part of a lifting cylinder 33.

The curvilinear portion has a radius of curvature of between 20 and 100 mm.

Advantageously, the curvilinear portion is configured to surround a portion of a lifting cylinder and increase the visibility of the driver of the lift truck.

The lifting cylinder, schematically illustrated with the reference numeral 33, is configured to move the telescopic cross-section, that is to say, the pair of second profiles 6 and the pair of third profiles 13 depending on whether the upright is of the duplex or triplex type.

With reference to the transversal cross section, in particular “J”, of the first profiles 5, the second flange 9 has a longitudinal length greater than that of the first flange 8.

The first flange 8 has a greater thickness at the join of the first end 8a to the core 7.

Advantageously, the increase allows the rigidity of the first profile in the side for supporting the forks to be increased.

At the join between the first end 8a and the core 7 the first profile 5 has a radius of curvature which is between 5 and 20 mm.

Each second profile 6 of the telescopic section 4 comprises a main body 10 interposed between a first flange 11 and a second flange 12 at a centre line position of the first flange 10 and the second flange 12 in such a way as to define the I-shaped cross section.

With reference to the I-shaped cross section, the first flange 11 and the second flange 12 extend along a main longitudinal direction and each is provided with a first end 11a, 12a, positioned along a same side of the respective second profile 6, and a second end 11b, 12b, positioned along a same side of the respective second profile 6.

The first end 11a of the first flange 11 and the second end 12b of the second flange 12 have surfaces inclined and parallel to each other.

The second end 11b of the first flange 11 and the first end 12a of the second flange 12 have surfaces inclined and parallel to each other.

The term inclined is used to mean relative to a main longitudinal direction of extension of the main body 10.

The first end 11a of the first flange 11 and the first end 12a of the second flange 12 of each second profile 6 are inserted in the compartment 19 of a respective first profile 5 in such a way as to define a chamber configured to house at least partly rolling means 30 of the second profile 6.

According to an embodiment not illustrated, it should be noted that if the telescopic cross section 4 has a single pair of second profiles 6, they have, on the opposite side of the chamber for housing rolling means defined with the first profiles 5, a compartment for housing respective rolling means of the pickup unit 2.

As will be described below, according to the embodiment illustrated, the second profiles 6 define a chamber for housing means 31 for rolling further profiles of the telescopic section 4.

The core 7 of each first profile 5 comprises a first portion 7a having an inclined surface parallel to the inclined surface of the first end 11a of the first flange 11 of the second profile 6 and a second portion 7b having an inclined surface parallel to the inclined surface of the first end 12a of the second flange 12 of the second profile 6.

The inclined surfaces of the portions 7a, 7b of the core 7 of each first profile 5 face, respectively, the first end 11a of the first flange 11 of the second profile 6 and the first end 12a of the second flange 12 of the second profile 6.

Advantageously, the presence of inclined parallel surfaces of the first profile 5 and of the second profile 6 allow the dimensions of the upright to be minimised and the inertia to be maximised.

According to the embodiment illustrated, the telescopic section 4 comprises a pair of third profiles 13 positioned parallel to each other and each third profile 13 has an I-shaped cross section.

The third profiles 13 are mobile relative to the second profiles 6 and the first profiles 5.

Each third profile 13 of the telescopic section 4 comprises a main body 14 interposed between a first flange 15 and a second flange 16 at a centre line position of the first flange 15 and the second flange 16 in such a way as to define the I-shaped cross section.

The second flange 16 of the third profile 13, in particular at the first end 16a of the second flange 16, is positioned in at least part of a compartment 20 delimited by the first flange 11 and by the second flange 12 of the second profile 6, positioned on the opposite side of the chamber for housing rolling means defined with the first profiles 5, in such a way as to define a chamber configured to house rolling means 31 of the third profile 13.

The first flange 15 and the second flange 16 extend along a main longitudinal direction and each is provided with a first end 15a, 16a, positioned along a same side of the respective third profile 13 and a second end 15b, 16b, positioned along a same side of the respective third profile 13.

The first end 15a of the first flange 15 and the second end 16b of the second flange 16 have surfaces inclined and parallel to each other.

The second end 15b of the first flange 15 and the first end 16a of the second flange 16 have surfaces inclined and parallel to each other.

The term inclined is used to mean relative to a main longitudinal direction of extension of the main body 14.

The central body 10 of each second profile 6 comprises at least one portion 10a having an inclined surface parallel to the inclined surface of the first end 16a of the second flange 16 of the third profiles 13.

The inclined surface of the portion 10a of the main body 10 of each second profile 6 faces the first end 16a of the second flange 16 of the third profile 13.

The central body 14 of the third profiles 13 comprises at least one portion 14a having an inclined surface parallel to the inclined surface of the second end 11b of the first flange 11 of the second profiles 6.

The inclined surface of the portion 14a of the main body 14 of each third profile 13 faces the second end 11b of the first flange 11 of the second profile 6.

The third profiles 13 are positioned relative to the respective second profile 6 in such a way that the first flange 11 of the second profile 6 is positioned in at least part of the compartment 20 delimited by the first flange 15 and by the second flange 16 of the third profile 13.

In this way, the first flange 15 of the third profile 13 is aligned with the first flange 8 of the first profile 5.

In other words, the first flange 11 of the second profile 6 faces a respective first flange 8 of the first profile 5 and first flange 15 of the third profile 13.

The second end 8b of the first flange 8 of the first profiles 5 has an inclined surface parallel to the inclined surface of the first end 15a of the first flange 15 of the third profiles 13.

The third profiles 13 of the telescopic section 4 support the pickup unit 2 and in a compartment 21 of the third profiles 13 defined by the second end 15b of the first flange 15 and by the second end 16b of the second flange 16 are positioned respective rolling means 32 for moving the gripping unit 2.

This invention also relates to a lift truck 17 comprising a driver's cab 18 and an upright 1 positioned in front of the driver's cab 18 in such a way that each second flange 9, 12 of the first profile 5 and of the second profile 6 are oriented on the side of the driver's cab 18.

1. An upright of a lift truck having a main extension along a vertical direction and comprising a unit for picking up a load;
the upright comprises a fixed section and at least one telescopic section, movable relative to the fixed section;
the fixed section comprises a pair of first profiles, positioned parallel to each other;
each cross-section of the first profile of the fixed section comprises a core which extends mainly along a longitudinal direction, a first flange, positioned facing the gripping unit, and a second flange which extend transversely relative to the core;
the first flange has a longitudinal extension greater than the second flange, with reference to a direction transversal to the longitudinal extension of the core;
each first flange and second flange is provided with a first end and a second end positioned along a same side of the respective first profile;
the first end of the first flange and of the second flange are positioned on the side facing towards the outside of the upright;
the first flange and the second flange are positioned parallel and spaced with respect to each other to define with the core a compartment configured to house at least part of the telescopic section;
characterised in that, with reference to the cross-section of the first profile of the fixed cross-section,
the first end of the first flange and the first end of the second flange have, respectively, a face which is inclined relative to a longitudinal direction of extension of the core;
the inclined face of the first end of the first flange is inclined by an angle “α” of between 2° and 20°, preferably 5°;
the inclined face of the first end of the second flange is inclined at an angle “β” of between 2° and 20°, preferably 12°.

2. The upright according to independent claim 1, wherein the second end of the second flange has a curvilinear portion configured to enclose at least part of a lifting cylinder.

3. The upright according to claim 1, wherein the second end of the first flange has an face inclined relative to a longitudinal direction of extension of the core of between 2° and 20°, preferably 5°.

4. The upright according to claim 1, the first flange has a greater thickness at the join of the first end to the core, preferably at the join of the first end to the core the first profile has a radius of curvature of between 6 and 10 mm.

5. The upright according to claim 1, wherein the telescopic section comprises at least a pair of second profiles, positioned parallel to each other, wherein each second profile has an I-shaped cross-section;
at least part of the I-shaped profile is inserted in the compartment of a respective first profile in such a way as to define a chamber configured to at least partly rolling means of the second profile.

6. The upright according to claim 5, wherein each second profile of the telescopic section comprises a main body interposed between a first flange and a second flange at a centre line position of the first flange and of the second flange in such a way as to define an I-shaped cross section;
the first flange and the second flange extend along a main transversal direction, relative to the longitudinal direction of the main body, and each is provided with a first end and a second end positioned along a same side of the respective second profile;
the first end of the first flange and the second end of the second flange have faces inclined and parallel to each other;
the second end of the first flange and the first end of the second flange have faces inclined and parallel to each other.

7. The upright according to claim 6, wherein the core of each first profile comprises a first portion having an inclined face parallel to the inclined surface of the first end of the first flange of the second profile and a second portion having an inclined face parallel to the inclined surface of the first end of the second flange of the second profile;
the inclined surfaces of the portions of the core of each first profile face, respectively, the first end of the first flange of the second profile and the first end of the second flange of the second profile.

8. The upright according to claim 5, wherein the central body of each second profile comprises at least one portion having an inclined surface parallel to the inclined surface of the first end of the second flange of the third profiles; the inclined surface of the portion of the main body of each second profile faces the first end of the second flange of the third profile.

9. The upright according to claim 1, wherein the telescopic section comprises a pair of third profiles positioned parallel to each other and each third profile has an I-shaped cross section;
each third profile of the telescopic section comprises a main body interposed between a first flange and a second flange at a centre line position of the first flange and the second flange;
the first flange and the second flange extend along a main longitudinal direction and each is provided with a first end and a second end positioned along a same side of the respective third profile;
the first end of the first flange and the second end of the second flange have faces inclined and parallel to each other;
the second end of the first flange and the first end of the second flange have faces inclined and parallel to each other.

10. The upright according to claim 9, wherein the central body of the second profiles has a portion having an inclined face parallel to the inclined face of the first end of the second flange of the third profiles;
and that the central body of the third profiles comprises at least one portion having an inclined face parallel to the inclined surface of the second end of the first flange of the second profiles;
the inclined face of the portion of the main body of each third profile faces the second end of the first flange of the second profile.

11. The upright according to claim 7, wherein the first end of the first flange of the first profiles has an inclined face parallel to the inclined surface of the first end of the first flange of the third profiles.

12. The upright according to any of claim 7, wherein the first flange of the third profile is aligned with the first flange of the first profile; the first flange of the second profile faces a respective first flange of the first profile and first flange of the third profile.

13. A lift truck comprising a driver's cab and an upright according to claim 1 positioned in front of the driver's cab in such a way that each second flange of the first profile and of the second profile are oriented on the side of the driver's cab.
